(19) United States
(12) Patent Application Publication
(10) Pub. No.: US 2026/0252204 A1
(43) Pub. Date: Aug. 27, 2026

(54) METHOD AND APPARATUS FOR DISPLAYING INTERFACE ELEMENT, DEVICE, MEDIUM AND PROGRAM PRODUCT

(71) Applicant: Beijing Zitiao Network Technology Co., Ltd., Beijing (CN)

(72) Inventor: Ziyan LI, Beijing (CN)

(21) Appl. No.: 19/547,951

(22) Filed: Feb. 24, 2026

(30) Foreign Application Priority Data
Feb. 25, 2025 (WO) PCT/CN2025/079067

(51) Int. Cl. G06F 3/0481; G06T 13/00

(52) U.S. Cl. CPC G06F 3/0481; G06T 13/00; G06T 2200/24; G06T 2210/62

(57) ABSTRACT

Embodiments of the present disclosure relate to a method and apparatus for displaying an interface element, a device, a medium and a program product. The method includes obtaining performance of a target device, and wherein a user interface of the target device is used to display the interface element. The method also includes in response to the performance being lower than threshold performance, associating a target attribute of the interface element with a first curve for presenting an animation effect. The method also includes determining, based on a plurality of parameters of a second curve for presenting an animation effect, a display duration of the interface element for the first curve. The method further includes displaying the interface element based on the first curve and the display duration.

### CROSS-REFERENCE TO RELATED APPLICATIONS

This application claims priority to International Patent Application No. PCT/CN2025/079067 filed on February 25, 2025, the disclosure of which is incorporated herein by reference in its entity.

### FIELD

Embodiments of the present disclosure generally relate to the field of user interaction, and more specifically, to a method and apparatus for displaying an interface element, a device, a medium and a program product.

### BACKGROUND

At present, actual interactive experience of the user is affected by many factors during user interaction. User interface contains a plurality of interface elements, some of which are used to display and interact with related operations of user, some interface elements are only used as decorations of user interface, and some further interface elements are present only after specific operations or specific target objects appear and may be displayed in association with the target objects, so as to enhance user experience during actual interaction.

Nowadays, more and more attention has been paid to user interaction and aesthetically pleasing interface elements and satisfactory interaction experience are currently pursued by people. For this, the design of the user interface has become a vital part. An excellent user interface design provides user with an immersive experience and increases the retention rate of user in the user interface. Therefore, it is of a growing importance to provide a better design for the user interface and enhance user experience.

### SUMMARY

Embodiments of the present disclosure provide a method and apparatus for displaying an interface element, a device, a medium and a program product.

In accordance with a first aspect of the present disclosure, a method for displaying an interface element is provided. The method includes obtaining performance of a target device, and wherein a user interface of the target device is used to display the interface element. The method also includes in response to the performance being lower than threshold performance, associating a target attribute of the interface element with a first curve for presenting an animation effect. The method also includes determining, based on a plurality of parameters of a second curve for presenting an animation effect, a display duration of the interface element for the first curve. The method further includes displaying the interface element based on the first curve and the display duration.

In accordance with a second aspect of the present disclosure, an apparatus for displaying an interface element is provided. The apparatus includes a performance obtaining module, configured to obtain performance of a target device, and wherein a user interface of the target device is used to display the interface element; a target attribute associating module, configured to, in response to the performance being lower than threshold performance, associate a target attribute of the interface element with a first curve for presenting an animation effect; a display duration determining module, configured to determine, based on a plurality of parameters of a second curve for presenting an animation effect, a display duration of the interface element for the first curve; and an interface element display module, configured to display the interface element based on the first curve and the display duration.

In accordance with a third aspect of the present disclosure, an electronic device is provided, and the electronic device includes at least one processor; and a storage apparatus, configured to store at least one program, the at least one program, when executed by the at least one processor, causes the at least one processor to implement the method according to the first aspect of the present disclosure.

In accordance with a fourth aspect of the present disclosure, a computer-readable storage medium is provided. The computer-readable storage medium storing a computer program thereon, the computer program, when executed by a processor, implements the method according to the first aspect of the present disclosure.

In accordance with a fifth aspect of the present disclosure, a computer program product is provided. The computer program product includes a computer program, the computer program, when executed by a processor, implements the method according to the first aspect of the present disclosure.

It should be appreciated that the contents described in this Summary are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for displaying an interface element according to some embodiments of the present disclosure;

FIG. 3 illustrates a schematic diagram of an example of a flowchart for displaying an interface element according to some embodiments of the present disclosure;

FIG. 4 illustrates a schematic diagram of an example code for determining display duration according to some embodiments of the present disclosure;

FIG. 5 illustrates a schematic diagram of an example for fitting the second curve with the first curve in accordance with some embodiments of the present disclosure;

FIG. 6 illustrates a schematic diagram of an example code for optimizing the first curve according to some embodiments of the present disclosure;

FIG. 7 illustrates a schematic diagram of an example of comparison of the first curve before and after the optimization according to some embodiments of the present disclosure;

FIG. 8 illustrates a schematic block diagram of an apparatus for displaying an interface element according to some embodiments of the present disclosure;

FIG. 9 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

In modern user experience design, animation and transitions are vital means to enhance the smoothness of user interface interaction and visual appeal. Spring animation and Bezier curve are two common animation interpolation methods respectively applied to different scenarios, where the Elastic curve generates natural and dynamic animation effects by simulating physical characteristics of a spring. Such method is suitable for interactive scenarios that emphasize physical sensations. The Bezier curve, however, defines animation tracks via control points, to provide an interpolation method with high controllability and computation efficiency.

However, in practice, the computation of the Spring animation is rather complicated. Especially when the related computation is executed on the low-performance device, it may cause frame drop and animation lag, which may further affect user experience. Moreover, when the computation is performed using Spring animation, there are certain requirements for device performance since it is required to produce natural and dynamic animation effects with strong physical sensations. The Bezier curve, however, is adapted to scenarios with relatively high-performance requirements. In existing animation designs for the user interface, the above two interpolation methods tend to cause frame drops and lags if the device performs poorly. This also affects the user experience to a great extent.

To at least solve the above and other potential problems, embodiments of the present disclosure provide a method for displaying an interface element. In this method, a computing device may first obtain performance of a device, a user interface of the device may be used to display an interface element. Besides, after it is determined that the performance is below threshold performance, a target attribute of the interface element is associated with a first curve for presenting an animation effect. Then, a display duration of the interface element for the first curve is determined based on a plurality of parameters of a second curve for presenting an animation effect. In the end, the computing device may display the interface element based on the first curve and the display duration. By this method, the attribute of the interface element is associated with the first curve and the display process of the attribute is controlled by an animation duration of the second curve, to generate an animation effect closer to the second curve using the first curve. Therefore, fewer resources are consumed and user interaction experience is enhanced.

It is to be understood that the present disclosure is described only with reference to related embodiments, but the protection scope of the present disclosure should not be restricted by the related embodiments. Any technical solutions in other disclosure should also be protected as long as they fall within the claimed protection scope.

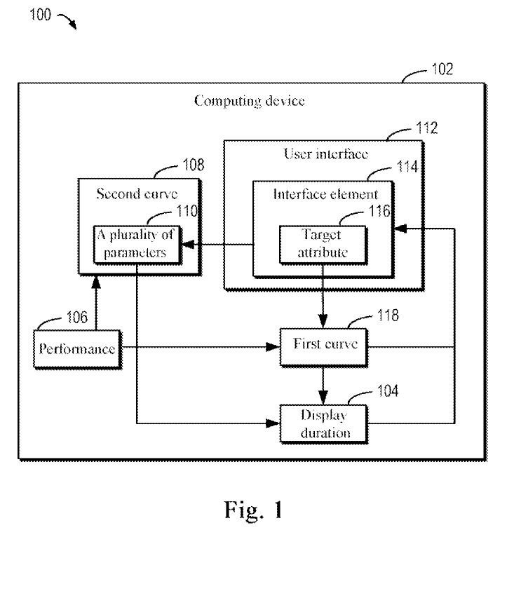

Embodiments of the present disclosure are to be described in details below with reference to the drawings. FIG. 1 illustrates an example environment in which the device and/or method of the embodiments of the present disclosure may be implemented. In the environment 100, the computing device 102 may detect the performance of the computing device 102. Moreover, the computing device 102 also may obtain attribute information of an interface element in the user interface.

Examples of the computing device 102 include, but not limited to, personal computer, server computer, hand-held or laptop device, mobile device (e.g., mobile phone, Personal Digital Assistant (PDA), and media player etc.), multi-processor system, consumer electronic product, minicomputer, large-scale computer, and a distributed computing environment including any of the above systems or devices.

As shown in FIG. 1, the computing device 102 may detect its own performance 106. The performance 106 of the computing device 102 may be determined according to some parameters of the computing device 102, e.g., temperature information, electricity consumption information and processor utilization rate of the computing device 102.

The user interface 112 is used to display an interface element 114. It is to be explained that the type of the interface element 114 may be any element suitable for display in the user interface 112 and will not be restricted in the present disclosure. In one example, the interface element 114 may be employed for interaction. In a further example, the user interface 114 is not available for interaction.

Next, after obtaining the performance 106 of the target device, the computing device 102 compares the obtained performance 106 with the threshold performance. The computing device 102 may further process the interface element 114 in accordance with a comparison result between the performance 106 and the threshold performance. The interface element 114 may include a target attribute 116. The target attribute may be presented by a curve. In some embodiments, the target attribute 116 may include at least one of: displacement, transparency or scaling.

For example, when the performance 106 is below the threshold performance, it is determined that the target device is currently in a low performance state. In such case, the computing device 102 may associate the target attribute 116 in the interface element with the first curve 118, the first curve 118 is used to present an animation effect, e.g., the first curve 118 is used to present an animation effect of the interface element 114. For instance, the first curve 118 may be Bezier curve or any other suitable curves.

Then, the computing device 102 may obtain a plurality of parameters 110 of a second curve 108 for presenting an animation effect and determine a display duration 104 of the interface element 114 when being dynamically displayed via the first curve 118 in accordance with a plurality of parameters 110. For example, the second curve may be an elastic curve or any suitable curves. The elastic curve may also be known as Spring animation curve.

It is to be explained that the first curve 118 is different from the second curve 108 and the computation complexity of the first curve 118 is lower than that of the second curve 108. In other words, it puts a lower demand for the performance 106 of the target device to present the first curve 118 in the user interface 112 than the second curve 108 in the user interface.

Additionally, the method for calculating the display duration 104 for the first curve 118 using a plurality of parameters 110 may be customized by the user and the present disclosure is not restricted in this regard. In one example, the length of the display duration 104 may be 300 milliseconds. In another example, the length of the display duration may be 500 milliseconds.

In the end, the computing device 102 displays the interface element 114 based on the first curve 118 and the display duration 104. The computing device 102 displays the interface element 114 in the user interface 112 based on the display duration 104 determined using a plurality of parameters 110 of the second curve 108 and in combination with the first curve 118.

In one example, the display mode of the first curve 118 may be monotonic. For example, the first curve 118 is displayed in a monotonic increasing manner. In another example, there may be certain distance between the start point and the end point of the first curve 118.

By this method, the attribute of the interface element is associated with the first curve and the display process of the attributes is controlled by an animation duration of the second curve, so as to generate an animation effect closer to the second curve using the first curve. Therefore, fewer resources are consumed and the user interaction experience is enhanced.

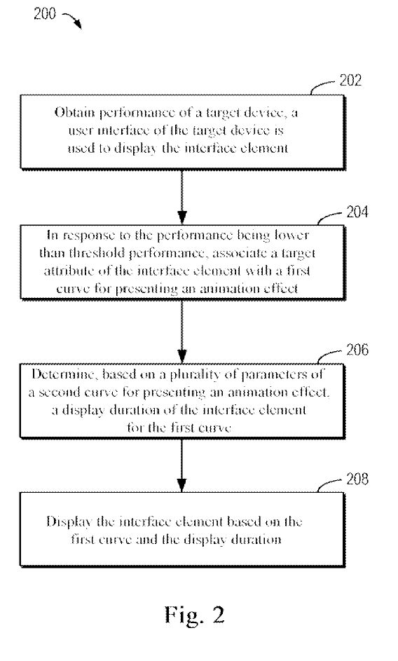

The schematic diagram of the example environment in which the device and/or method according to some embodiments of the present disclosure may be implemented has been described above with reference to FIG. 1. Next, a schematic diagram of an example method 200 for displaying an interface element according to some embodiments of the present disclosure is to be depicted below with reference to FIG. 2. The example method may be executed by the computing device 102 in FIG. 1 and/or any suitable computing devices.

As shown in FIG. 2, in the example method 200, at block 202, the performance of the target device is obtained and the user interface of the target device may be used to display an interface element. For example, if the computing device 102 is the target device, the performance of the computing device per se is obtained.

In some embodiments, the performance 106 of the target device may be determined according to some parameters of the target device. In one example, the computing device 102 may determine the performance 106 of the target device in accordance with the temperature information of the target device. In another example, the computing device 102 may determine the performance 106 of the target device in accordance with the electricity consumption information of the target device. In a further example, the computing device 102 may determine the performance 106 of the target device in accordance with the processor utilization rate of the target device. In a further example, the computing device 102 may determine the performance 106 of the target device in accordance with two or more of the temperature information, the electricity consumption information and the processor utilization rate of the target device. The above examples are provided merely to describe the present disclosure, rather than restricting it. Those skilled in the art may configure what parameters of the target device are used to calculate the performance in view of the requirements.

In some embodiments, the user interface 112 may be used to display an interface element 114. The type of the interface element 114 may be any an element suitable for display in the user interface 112. In one example, the interface element 114 may be used for interaction. In another example, the interface element 114 is not available for interaction. In a further example, the interface element 114 may become interactive by receiving an operation on them. For example, the interface element 114 become interactive after a long press operation on it is received.

Next, at block 204, in response to the performance being below the threshold performance, a target attribute of the interface element is associated with the first curve for presenting the animation effect.

In some embodiments, after obtaining the performance 106 of the target device, the computing device 102 also obtains the threshold performance and then compares the obtained performance 106 with the threshold performance. Subsequently, the computing device 102 may further process the interface element 114 in accordance with a result of comparison between the performance 106 and the threshold performance.

After it is determined that the performance 106 is below the threshold performance, the computing device 102 also further determines a plurality of control points of the first curve 118 and the second curve 108 is fitted using a plurality of control points determined. In addition, the target attribute 116 corresponding to the interface element 114 is also associated with the first curve 118 having a plurality of control points.

In some embodiments, the computing device 102 also further determines the start point and the end point of the first curve 118 and then decides a first slope for the start point and a second slop for the end point. Besides, the computing device 102 also adjusts the first slope and the second slope according to a threshold slope. In such case, the computing device 102 would adjust the first slope or the second slope by comparing the first slope value with the threshold slope value or comparing the second slope value with the threshold slope value. In case that the first slope is greater than or equal to the threshold slope or the second slope is greater than or equal to the threshold slope, no adjustments are made to the slope of the curve.

For example, when the first slope is smaller than the threshold slope, the first slope is adjusted by adjusting a coordinate value of the start point of the first curve 118. In the example where the start point of the first curve 118 has the coordinates of (x1, y1) in the coordinate system, when the first slope is smaller than the threshold slope, the first slope is adjusted by adjusting the values of x1 and y1 in the start point (x1, y1) of the first curve 118. In one example, x1 and y1 may have equal values. In another example, the values of x1 and y1 may not be equal.

The threshold slope may also be used to adjust the second slope in addition to adjusting the first slope. In the example where the end point of the first curve 118 has the coordinates of (x2, y2) in the coordinate system, when the second slope is smaller than the threshold slope, the second slope is adjusted by modifying the values of x2 and y2 in the end point (x2, y2) of the first curve 118. In one example, values of x2 and y2 may be equal. In another example, the values of x2 and y2 may not be equal. Additionally, the values of x1, x2, y1 and y2 are within an interval range from 0 to 1.

In some embodiments, x1 in the coordinates of the start point and x2 in the coordinates of the end point correspond to values on a first coordinate axis, and y1 in the coordinates of the start point and y2 in the coordinates of the end point correspond to values on a second coordinate axis. x1 in the coordinates of the start point corresponds to a first value on the first coordinate axis and x2 in the coordinates of the end point corresponds to a second value on the first coordinate axis. Besides, y1 in the coordinates of the start point corresponds to a third value on the second coordinate axis and y2 in the coordinates of the end point corresponds to a fourth value on the second coordinate axis.

After the first value and the second value of the start point and the end point on the first coordinate axis are determined, it is further determined whether the start point and the end point conflict on the first coordinate axis. The conflict may be determined by judging whether a sum of the value of x1 in the coordinates of the start point and the value of x2 in the coordinates of the end point is greater than 1.

If it is determined that the sum of the value of x1 in the coordinates of the start point and the value of x2 in the coordinates of the end point is greater than 1, it is required to adjust the first value and the second value, so as to decrease the first value and increase the second value. It is to be appreciated that the method for adjusting the first value and the second value may be configured as any suitable method by the user in view of the requirements and the present disclosure is not restricted in this regard.

Moreover, if it is determined that the third value is greater than the fourth value, the computing device 102 will adjust the third value and the fourth value, such that the adjusted third value is smaller than the adjusted fourth value. Additionally, the adjusted x1 and y1 in the coordinates of the start point are both smaller than the adjusted x2 and y2 in the coordinates of the end point.

In some embodiments, a plurality of control points corresponding to the first curve 118 also may be used to adjust the position of the start point and the position of the end point of the first curve 118. For example, the position of the start point and the position of the end point of the first curve 118 may be further adjusted by modifying the position of the control points.

In some embodiments, when the performance 106 obtained by the computing device 102 is greater than the threshold performance, the target attribute 116 of the interface element 114 is directly associated with the second curve 118 and the interface element 114 is displayed in the user interface 112 using the second curve 108.

Afterwards, at block 206, the display duration of the interface element for the first curve is determined based on a plurality of parameters of the second curve for presenting an animation effect.

It is to be explained that the first curve 118 is different from the second curve 108 and the computation complexity of the second curve 108 is higher than that of the first curve 118. In other words, it puts a higher demand for the performance 106 of the target device to present the second curve 108 in the user interface 112 than the first curve 118 in the user interface. In addition, the first curve 118 is Bezier curve and the second curve 108 is elastic curve.

In some embodiments, the second curve 108 includes a plurality of parameters 110, the plurality of parameters may be used to determine the display duration 104 of the interface element 114for the first curve 118. In one example, the length of the display duration 104 may be 400 milliseconds. In another example, the length of the display duration 104 may be 600 milliseconds.

In the end, at block 208, the interface element is displayed based on the first curve and the display duration. With the determined display duration 104, the interface element can be fully displayed in the user interface 112 by the first curve within the length of the display duration 104, to present the animation effect in the user interface 112 through fitting the first curve 118 to be close to the second curve 108.

By this method, the attribute of the interface element is associated with the first curve and the display process of the attribute is controlled by an animation duration of the second curve, to generate an animation effect closer to the second curve using the first curve. Therefore, fewer resources are consumed and user interaction experience is enhanced.

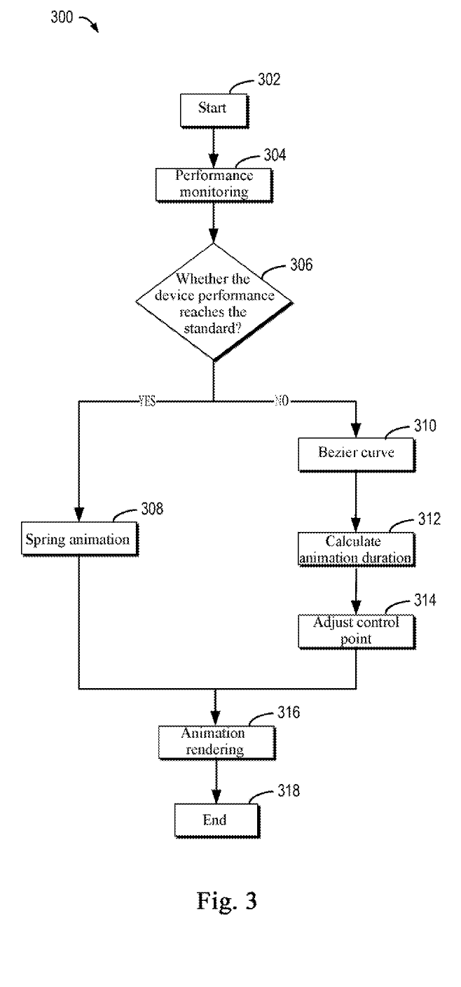

The schematic diagram of the example method for displaying an interface element in accordance with some embodiments of the present disclosure has been described above with reference to FIG. 2. Next, a schematic diagram of an example of a flowchart for displaying an interface element in accordance with some embodiments of the present disclosure is to be depicted in conjunction with FIG. 3.

In the example 300 of FIG. 3, when the flow begins at 302, the computing device 102 first monitors 304 the performance of the target device and further determines at 306 whether the device performance reaches the standard after the performance monitoring 304.

If the performance reaches the standard, i.e., the performance being greater than threshold performance, the target attribute of the interface element is directly associated with the elastic curve for displaying Spring animation 308. After animation rendering 316, the interface element is displayed on the user interface. The entire flow then ends at 318.

If the performance fails to reach the standard, i.e., the performance being smaller than threshold performance, the computing device 102 first associates the target attribute of the interface element with the Bezier curve 310 and then calculates the animation duration 312. The animation duration is determined based on a plurality of parameters in the elastic curve corresponding to the Spring animation 308.

After the animation duration is determined, the control points of the Bezier curve are further adjusted at 314, to further modify the position of the start point and the position of the end point of the Bezier curve, the slope of the start point and the slope of the end point.

Finally, the animation rendering is performed at 316, the corresponding interface element is displayed on the user interface, and the entire flow ends at 318.

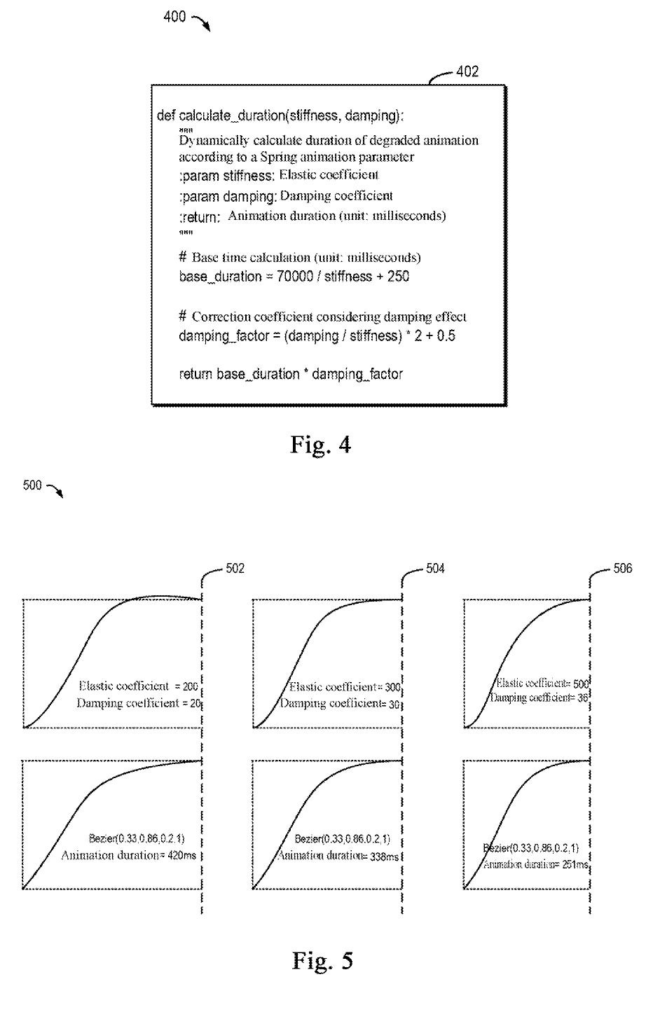

The schematic diagram of the example of the flowchart for displaying an interface element in accordance with some embodiments of the present disclosure has been described above with reference to FIG. 3. Next, a schematic diagram of example codes for determining the display duration in accordance with some embodiments of the present disclosure is to be depicted in conjunction with FIG. 4.

As shown in FIG. 4, in the example 400, param stiffness in the example code 402 indicates an elastic coefficient of the elastic curve, and param damping represents a damping coefficient of the elastic curve.

The computing device 102 may use a formula for calculating the animation duration in the example code 402 to calculate the animation duration. For example, a base time is calculated using the elastic coefficient. Then, a correction coefficient for the damping effect is determined based on the elastic coefficient and the damping coefficient. In the end, the calculated base time is multiplied by the correction coefficient to obtain the final animation duration.

By this method, the elastic curve is fitted using the Bezier curve and the process for generating the Bezier curve is controlled by the animation duration of the elastic curve, such that the degraded Bezier curve is much closer to the effects of the Spring animation and user experience during interaction is also improved.

The schematic diagram of the example code for determining the display duration in accordance with some embodiments of the present disclosure has been described above with reference to FIG. 4. Next, a schematic diagram of an example of fitting the second curve with the first curve in accordance with some embodiments of the present disclosure is to be depicted in conjunction with FIG. 5. The example may be executed by the computing device 102 in FIG. 1 or any suitable devices.

As shown in FIG. 5, the example 500 includes a curvilinear coordinate graph 502, a curvilinear coordinate graph 504 and a curvilinear coordinate graph 506. In the three coordinate graphs, the upper graph is the elastic curve graph and the lower graph is a curvilinear coordinate graph generated from fitting the elastic curve with the Bezier curve, and the four parameters of the Bezier curve respectively are 0.33, 0.86, 0.2 and 1.

In the curvilinear coordinate graph 502, the elastic coefficient is 200 and the damping coefficient is 20. In such case, the calculated animation duration is 420ms, and the target attribute of the interface element may be associated with the Bezier curve using the calculated animation parameters, to perform the fitting of the elastic curve.

In the curvilinear coordinate graph 504, the elastic coefficient is 300 and the damping coefficient is 30. In such case, the calculated animation duration is 338ms, and the target attribute of the interface element may be associated with the Bezier curve using the calculated animation parameters, to perform the fitting of the elastic curve.

In the curvilinear coordinate graph 506, the elastic coefficient is 500 and the damping coefficient is 36. In such case, the calculated animation duration is 251ms, and the target attribute of the interface element may be associated with the Bezier curve using the calculated animation parameters, to perform the fitting of the elastic curve.

The above selected four parameters of the Bezier curve are merely examples and do not restrict the present disclosure. Those skilled in the art may choose suitable parameters in accordance with the requirements below. For example, the choice of some of the four parameters of the Bezier curve is made within a certain numerical range. In one example, the first parameter shall not exceed 0.5; no range is defined for the second parameter; the third parameter shall not exceed 0.4; and the fourth parameter is 1.

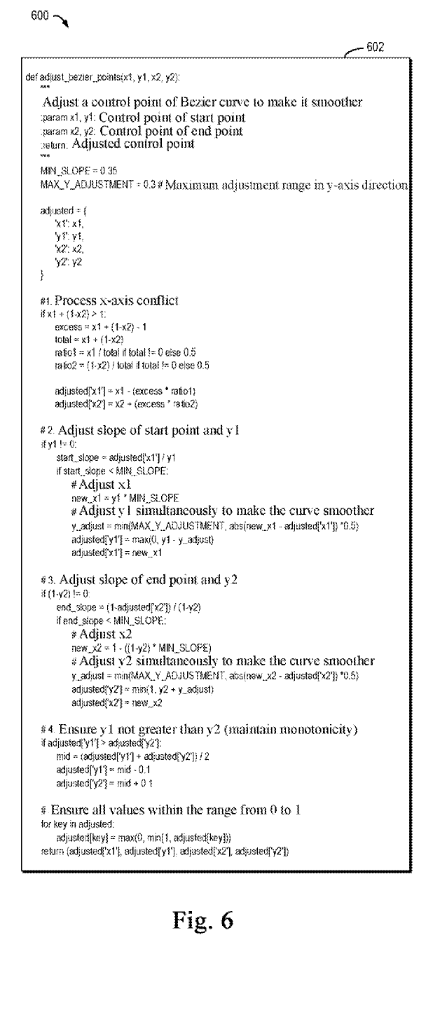

The schematic diagram of the example of fitting the second curve with the first curve in accordance with some embodiments of the present disclosure has been described above with reference to FIG. 5. Next, a schematic diagram of an example code for optimizing the first curve in accordance with some embodiments of the present disclosure is to be depicted in conjunction with FIG. 6.

For the Bezier curve, if the curve is too steep, the animation would vary dramatically, which may lead to frame drops in low-end devices. The control points of the Bezier curve are adjusted below to optimize the curve form and make the curve smoother. The animation performance of the low-end devices is also improved as a result.

As shown in FIG. 6, the example code for optimizing the first curve or the Bezier curve are demonstrated in the example 600, the coordinates x1 and x2 of the start point and the end point of the Bezier curve on the x-axis and the coordinates y1 and y2 of the start point and the end point of the Bezier curve on the y-axis are obtained in the first place. To facilitate the description, x1, x2, y1 and y2 are respectively referred to as a first value, a second value, a third value and a fourth value. Moreover, it is determined that the maximum adjustment range of the Bezier curve on the y-axis is 0.3 and the threshold slope or the minimum slope of the start point and the end point is 0.35.

Then, x-axis conflict is processed at #1 of the example codes. If it is determined that the sum of the value of x1 in the coordinates of the start point and the value of x2 in the coordinates of the end point is greater than 1, it is required to adjust the first value and the second value, so as to decrease the first value and increase the second value.

The slope of the start point and the third value are further adjusted at #2 of the example codes. If the slope of the start point is smaller than the threshold slope of 0.35, the slope of the start point is adjusted. For example, the third point and the slope of the start point are adjusted to make the curve smoother.

The slope of the end point and the fourth value are adjusted at #3 of the example codes. Similar to the adjustments at #2 of the example codes, if the slope of the end point is smaller than the threshold slope of 0.35, the slope of the end point is adjusted. For example, the fourth value and the slope of the end point are adjusted to make the curve smoother.

In addition to keeping the curve smooth, the monotonicity of the curve should also be maintained. The third value and the fourth value are further adjusted at #4 of the example codes. If the third value is greater than the fourth value, the third and fourth values are adjusted, such that the adjusted third value is smaller than the adjusted fourth value.

By this method, the elastic curve is fitted using the Bezier curve and the process for generating the Bezier curve is controlled by the animation duration of the elastic curve, such that the degraded Bezier curve is much closer to the effects of the Spring animation. Furthermore, the control points of the Bezier curve are also adjusted and optimized, to improve the smoothness of the curve and maintain its monotonicity. User experience during interaction is also enhanced.

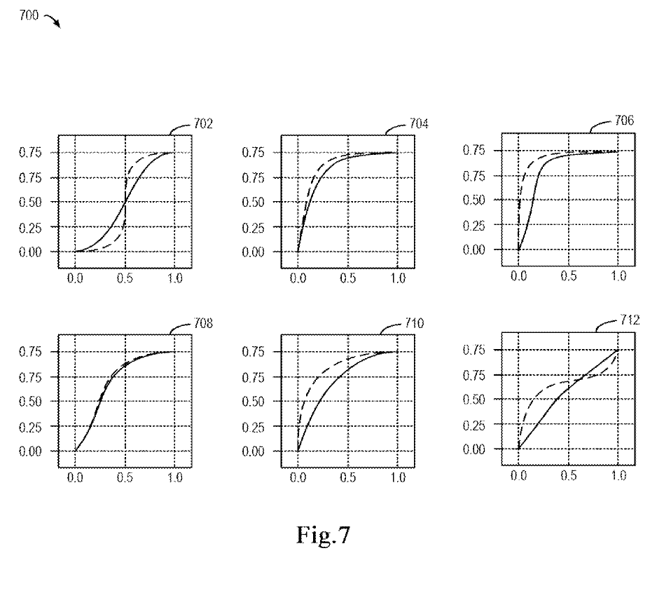

The schematic diagram of the example code for optimizing the first curve in accordance with some embodiments of the present disclosure has been described above with reference to FIG. 6. Next, a schematic diagram of an example of comparison of the first curve before and after the optimization in accordance with some embodiments of the present disclosure is to be depicted in conjunction with FIG. 7.

As shown in FIG. 7, the example 700 illustrates a plurality of coordinate graphs, including coordinate graph 702, coordinate graph 704, coordinate graph 706, coordinate graph 708, coordinate graph 710 and coordinate graph 712. Moreover, the values of the coordinates of the start point and the end point of the curve along the x-axis and the y-axis are all within the range from 0 to 1.

Each coordinate graph includes two curves, the dotted curve represents the curve before the adjustment and optimization, and the solid curve represents the adjusted and optimized curve. It can be seen that the curves before optimization are steep and less smooth and the monotonicity of the curves could not be visually observed.

The adjusted and optimized curves are smoother and have better continuity than the curves before the adjustment and optimization. Moreover, the monotonicity of the curves can be visually observed.

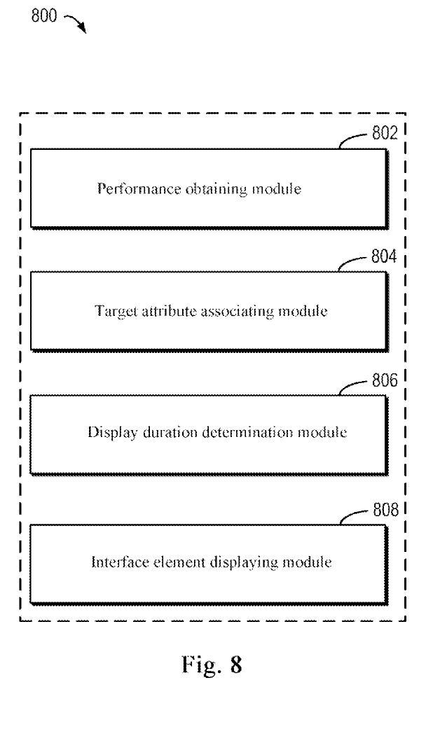

According to FIG. 8, the apparatus 800 includes a performance obtaining module 802, configured to obtain performance of a target device, and wherein a user interface of the target device is used to display the interface element; a target attribute associating module 804, configured to, in response to the performance being lower than threshold performance, associate a target attribute of the interface element with a first curve for presenting an animation effect; a display duration determination module 806, configured to determine, based on a plurality of parameters of a second curve for presenting an animation effect, a display duration of the interface element for the first curve; and an interface element display module 808, configured to display the interface element based on the first curve and the display duration.

In some embodiments, the target attribute associating module 804 includes: a module for determining a plurality of control points, configured to determine a plurality of control points of the first curve for fitting the second curve; and the target attribute associating module, configured to associate the target attribute with the first curve having the plurality of control points.

In some embodiments, the display duration determination module 806 includes: a module for determining elastic parameter and damping parameter, configured to determine an elastic parameter and a damping parameter included in the plurality of parameters; and the display duration determination module, configured to determine, based on the elastic parameter and the damping parameter, the display duration of the interface element for the first curve.

In some embodiments, the apparatus 800 also includes: a module for determining start point and end point of first curve, configured to determine a start point and an end point of the first curve; a module for determining first slope and second slope, configured to determine a first slope for the start point and a second slope for the end point; and a module for adjusting a first slope and a second slope, configured to determine, based on a threshold slope, adjustments to the first slope and the second slope.

In some embodiments, the apparatus 800 also includes: a module for determining first value and second value, configured to determine a first value of the start point for a first coordinate axis and a second value of the end point for the first coordinate axis; a module for determining conflict between start point and end point, configured to determine, based on the first value and the second value, whether the start point and the end point conflict on the first coordinate axis; and a module for adjusting first value and second value, configured to, in response to determining that the start point and the end point conflict on the first coordinate axis, adjust the first value and the second value.

In some embodiments, the module for adjusting first slope and second slope includes: a module for judging a first slope, configured to determine whether the first slope is smaller than the threshold slope; and a module for adjusting a coordinate value of start point, configured to, in response to the first slope being smaller than the threshold slope, adjust the first slope by adjusting a coordinate value of the start point.

In some embodiments, the module for adjusting a first slope and second slope includes: a module for judging second slope, configured to determine whether the second slope is smaller than the threshold slope; and a module for adjusting coordinate value of end point, configured to, in response to the second slope being smaller than the threshold slope, adjust the second slope by adjusting a coordinate value of the end point.

In some embodiments, the module for adjusting a first slope and a second slope includes: a module for determining a third value and a fourth value, configured to determine a third value of the start point for a second coordinate axis and a fourth value of the end point for the second coordinate axis; and a module for adjusting a third value and a fourth value, configured to, in response to the third value being greater than the fourth value, adjust the third value and the fourth value, such that the adjusted third value is smaller than the adjusted fourth value.

In some embodiments, the apparatus 800 also includes: a target attribute associating module, configured to, in response to the performance being greater than or equal to the threshold performance, associate the target attribute of the interface element with the second curve; and an interface element display module, configured to display the interface element based on the second curve.

In some embodiments, the apparatus 800 also includes: determining the performance of the target device based on at least one of: temperature information of the target device, electricity consumption information of the target device or processor utilization rate of the target device.

In some embodiments, the first curve is a Bezier curve, the second curve is an elastic curve, and computation complexity of the first curve is smaller than computation complexity of the second curve.

In some embodiments, the target attribute includes at least one of: displacement, transparency or scaling.

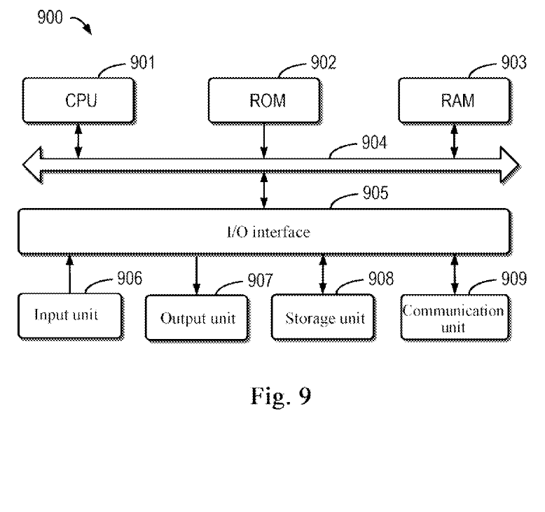

FIG. 9 illustrates a schematic block diagram of an example device 900 for implementing embodiments of the present disclosure. The computing device 102 in FIG. 1 may be implemented by the device 900. As shown in FIG. 9, the device 900 includes a central process unit (CPU) 901, which can execute various suitable actions and processing based on the computer program instructions stored in the read-only memory (ROM) 902 or computer program instructions loaded in the random-access memory (RAM) 903 from the storage unit 908. The RAM 903 can also store all kinds of programs and data required by the operation of the device 900. CPU 901, ROM 902 and RAM 903 are connected to each other via a bus 904. The input/output (I/O) interface 905 is also connected to the bus 904.

A plurality of components in the device 900 is connected to the I/O interface 905, including: an input unit 906, such as keyboard, mouse and the like; an output unit 908, e.g., various kinds of display and loudspeakers etc.; a storage unit 908, such as disk and optical disk etc.; and a communication unit 909, such as network card, modem, wireless transceiver and the like. The communication unit 909 allows the device 900 to exchange information/data with other devices via the computer network, such as Internet, and/or various telecommunication networks.

The above described procedure and processing, such as method 200 and examples 300-700, can be executed by the processing unit 901. For example, in some embodiments, method 200 and examples 300-700 can be implemented as a computer software program tangibly included in the machine-readable medium, e.g., storage unit 908. In some embodiments, the computer program can be partially or fully loaded and/or mounted to the apparatus 900 via ROM 902 and/or communication unit 909. When the computer program is loaded to RAM 903 and executed by the CPU 901, one or more actions of the above described example method 200 and examples 300-700.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, the programming languages includes object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions includes an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

I/We claim:

1. A method for displaying an interface element, comprising:
obtaining performance of a target device, a user interface of the target device being used to display the interface element;
in response to the performance being lower than threshold performance, associating a target attribute of the interface element with a first curve for presenting an animation effect;
determining, based on a plurality of parameters of a second curve for presenting an animation effect, a display duration of the interface element for the first curve; and
displaying the interface element based on the first curve and the display duration.

2. The method of claim 1, wherein associating the target attribute of the interface element with the first curve for presenting the animation effect comprises:
determining a plurality of control points of the first curve for fitting the second curve; and
associating the target attribute with the first curve having the plurality of control points.

3. The method of claim 1, wherein determining the display duration of the interface element for the first curve comprises:
determining an elastic parameter and a damping parameter comprised in the plurality of parameters; and
determining, based on the elastic parameter and the damping parameter, the display duration of the interface element for the first curve.

4. The method of claim 1, further comprising:
determining a start point and an end point of the first curve;
determining a first slope for the start point and a second slope for the end point; and
determining, based on a threshold slope, adjustments to the first slope and the second slope.

5. The method of claim 4, further comprising:
determining a first value of the start point for a first coordinate axis and a second value of the end point for the first coordinate axis;
determining, based on the first value and the second value, whether the start point and the end point conflict on the first coordinate axis; and
in response to determining that the start point and the end point conflict on the first coordinate axis, adjusting the first value and the second value.

6. The method of claim 4, wherein determining, based on the threshold slope, the adjustments to the first slope and the second slope comprises:
determining whether the first slope is smaller than the threshold slope; and
in response to the first slope being smaller than the threshold slope, adjusting the first slope by adjusting a coordinate value of the start point.

7. The method of claim 6, wherein determining, based on the threshold slope, the adjustments to the first slope and the second slope comprises:
determining whether the second slope is smaller than the threshold slope; and
in response to the second slope being smaller than the threshold slope, adjusting the second slope by adjusting a coordinate value of the end point.

8. The method of claim 7, further comprising:
determining a third value of the start point for a second coordinate axis and a fourth value of the end point for the second coordinate axis; and
in response to the third value being greater than the fourth value, adjusting the third value and the fourth value, such that the adjusted third value is smaller than the adjusted fourth value.

9. The method of claim 1, further comprising:
in response to the performance being greater than or equal to the threshold performance, associating the target attribute of the interface element with the second curve; and
displaying the interface element based on the second curve.

10. The method of claim 1, further comprising:
determining the performance of the target device based on at least one of:
temperature information of the target device, electricity consumption information of the target device, or processor utilization rate of the target device.

11. The method of claim 1, wherein the first curve is a Bezier curve, the second curve is an elastic curve, and computation complexity of the first curve is smaller than computation complexity of the second curve.

12. The method of claim 1, wherein the target attribute comprises at least one of: displacement, transparency, or scaling.

13. An electronic device, comprising:
at least one processor; and
a memory, configured to store at least one program, wherein the at least one program, when executed by the at least one processor, causes the at least one processor to:
obtain performance of a target device, a user interface of the target device being used to display the interface element;
in response to the performance being lower than threshold performance, associate a target attribute of the interface element with a first curve for presenting an animation effect;
determine, based on a plurality of parameters of a second curve for presenting an animation effect, a display duration of the interface element for the first curve; and
display the interface element based on the first curve and the display duration.

14. The electronic device according to claim 13, wherein the at least one program causing the at least one processor to associate a target attribute of the interface element with a first curve for presenting an animation effect further causes the at least one processor to:
determine a plurality of control points of the first curve for fitting the second curve; and
associate the target attribute with the first curve having the plurality of control points.

15. The electronic device according to claim 13, wherein the at least one program causing the at least one processor to display the interface element based on the first curve and the display duration further causes the at least one processor to:
determine an elastic parameter and a damping parameter comprised in the plurality of parameters; and
determine, based on the elastic parameter and the damping parameter, the display duration of the interface element for the first curve.

16. The electronic device according to claim 13, wherein the at least one program further causes the at least processor to:
determine a start point and an end point of the first curve;
determine a first slope for the start point and a second slope for the end point; and
determine, based on a threshold slope, adjustments to the first slope and the second slope.

17. The electronic device according to claim 16, wherein the at least one program further causes the at least processor to:
determine a first value of the start point for a first coordinate axis and a second value of the end point for the first coordinate axis;
determine, based on the first value and the second value, whether the start point and the end point conflict on the first coordinate axis; and
in response to determining that the start point and the end point conflict on the first coordinate axis, adjust the first value and the second value.

18. The electronic device according to claim 16, wherein the at least one program causing the at least one processor to determine, based on a threshold slope, adjustments to the first slope and the second slope further causes the at least processor to:
determine whether the first slope is smaller than the threshold slope; and
in response to the first slope being smaller than the threshold slope, adjust the first slope by adjusting a coordinate value of the start point.

19. The electronic device according to claim 18, wherein the at least one program causing the at least one processor to determine, based on a threshold slope, adjustments to the first slope and the second slope further causes the at least processor to:
determine whether the second slope is smaller than the threshold slope; and
in response to the second slope being smaller than the threshold slope, adjust the second slope by adjusting a coordinate value of the end point.

20. A non-transitory computer-readable storage medium storing a computer program thereon, wherein the computer program, when executed by a processor, causes the processor to:
obtain performance of a target device, a user interface of the target device being used to display the interface element;
in response to the performance being lower than threshold performance, associate a target attribute of the interface element with a first curve for presenting an animation effect;
determine, based on a plurality of parameters of a second curve for presenting an animation effect, a display duration of the interface element for the first curve; and
display the interface element based on the first curve and the display duration.
